(19) United States
(12) Patent Application Publication
(10) Pub. No.: US 2015/0013885 A1
(43) Pub. Date: Jan. 15, 2015

(54) SELF SUPPORTING PREPREG WITH TACK FOR USE IN AUTOMATIC PROCESS FOR LAYING UP PREPREG TO FORM THREE DIMENSIONAL PARTS

(71) Applicant: Henkel IP & Holding GmH, Duesseldorf (DE)

(72) Inventor: Wei Helen Li, San Ramon, CA (US)

(21) Appl. No.: 14/300,347

(22) Filed: Jun. 10, 2014

Related U.S. Application Data
(63) Continuation of application No. PCT/US2012/055357, filed on Sep. 14, 2012.
(60) Provisional application No. 61/564,518, filed on Nov. 29, 2011.

(51) Int. Cl. B32B 37/10

(52) U.S. Cl. CPC B32B 37/1009; B32B 2309/70
USPC 156/166

(57) ABSTRACT

Self supporting prepreg with tack for use in automatic process for laying up prepreg to form three dimensional parts is provided herein.

### BACKGROUND

Structural performance advantages of composites, such as carbon fiber epoxy and bismaleimide (BMI) materials, are widely known in the aerospace industry. Aircraft designers have been attracted to composites because of their superior stiffness, strength and radar absorbing capabilities, for example. As more advanced materials and a wider variety of material forms have become available, aerospace usage of composites has increased.

Automated tape layer technology has developed to become a widely used automated process for fabricating large composite structures, such as wing panels and empennage. Current tape layer technology has been improved to offer flexibility in process capabilities required for a wide variety of aerospace components. As aerospace industry tape laying applications achieve material lay up rates, for example, that may help control the manufacturing cost of large composite structures, new and innovative applications for tape layers may be defined, such as the automated tape lay-up of large aircraft fuselage sections, for example, 15 to 20 feet in diameter.

Automatic tape laying machines and automatic fiber placement machines are used to apply uncured composite material (or, prepreg) to molds during fabrication of composite parts. Such machines are particularly desirable for fabricating large composite parts, such as aircraft fuselages, wing skins and wind turbine blades. These machines have a movable tape delivery head, which is computer controlled to move about multiple axes and deliver a prepreg tape to a variety of mold shapes. For a more detailed description of automated tape laying machines, see Gramshaw et al., “Advanced Technology Tape Laying for Affordable Manufacturing of Large Composite Structures” 46^{th} International SAMPE Symposium, pp. 2484-94 (May 6-10, 2001). For a generic description of automated tape layer and automated fiber placement delivery head, see U.S. Patent Application Publication No. 2005/0039842.

Automated tape layer and automated fiber placement delivery systems are similar with the former laying down a single width of prepreg tape taken from a single reel and the latter laying down one or more narrow preslit prepreg taken from one or more individual reels.

A problem with the present systems for laying up prepreg is that the resin matrix in the prepreg confers tack to the prepreg. This tack can lead to resin buildup at various stages of the layup process. In order to address resin buildup during application, the machines are stopped with some frequency to clean away excess resin from the machine.

One way to alleviate this problem is to layup prepreg under reduced temperature conditions. By so doing, resin buildup is minimized and the attendant issues associated with resin buildup have been addressed.

However, reducing the temperature of the environment in which the prepreg layup occurs is not without cost. As many of the requisite parts to be manufactured are quite large (such as those destined for use in airplane assembly), the floor space blue print needs to be large enough to accommodate one or more of such parts. The energy costs associated with reducing the temperature, particularly in warmer weather climates, of such facilities can be significant.

In addition, the prepreg tape used in these machines contains a layer of prepreg supported on a backing. The backing, which is removed as the tape is placed onto the mold by the delivery head, is typically paper or sometimes polyethylene. The surface of the backing should not stick to the prepreg as the tape is being unwound from the supply roll. In order to function properly, the prepreg is adhered to the backing until it reaches the delivery head, where it is differentially released onto the mold or onto previously applied prepreg. The prepreg tape is provided as a large roll or spool mounted on the machine for feeding to the delivery head.

After the prepreg tape has been placed on the mold, the backing is removed and wound onto a take up roller. As a result, there is continuous tension on the backing between the supply roll, delivery head and the take up roll. The prepreg is also typically heated at the delivery head and a certain amount of compaction pressure is applied to adhere the prepreg to the mold or to previously applied layers of prepreg. In addition, the machine lays the prepreg tape in a computer-controlled path and cuts through the prepreg at precisely controlled locations and angles.

The backing oftentimes breaks as it passes from the supply roll to the take up roll. Stopping and restarting automated prepreg application machines due to the breakage of the backing is a costly and time-consuming operation, which is desirable to avoid.

U.S. Pat. No. 5,472,553 provides an apparent solution to the problem of backing breakage. The '533 patent refers to an apparatus for placing tows of resin impregnated fibers on a tool, the fibers being releasably attached to a backer and moving through the apparatus along a flow path, the apparatus comprising:

a plurality of rotatable tow cassette reels of tows for dispensing the tows;

first row tensioning means attached to the tow cassette reels for maintaining constant tension on the tows during placement on the tool;

a guide pulley assembly, the assembly comprised of a plurality of pulleys individually rotatable on a shaft for guiding each of the tows through the apparatus along the flow path;

tow cutting means for cutting the tows to a predetermined length and shape after the tows exit from the guide pulley assembly;

encoder pulley means for guiding the tows after passing through the cutting means and for determining the position of each of the tow ends when the tows are placed on the tool;

means for removing the backers from the tows and storing the backers on backer cassette reels;

second tow tensioning means attached to the backer cassette reels for controlling the tension on the tows in conjunction with the first tow tensioning means attached to the tow cassette reels, the second tow tensioning means acting in the opposite direction of the first tow tensioning means to minimize the tension on the tow when the tow is placed on the tool;

drive means for driving each of the tows individually in response to a predetermined pattern;

control means for controlling the drive means and the tow cutting means in response to the outputs of both the encoder pulleys and a predetermined pattern installed in the control means; and

a tow placement head for receiving the cut tows and placing them on the tool surface.

U.S. Patent Application Publication No. 2010/0282404 provides backing materials that are multi-layer substrates and tear resistant. The '404 publication provides a tape for use in an automated tape laying machine, is defined to include:

a multi-layer substrate for supporting the uncured composite material during use of the tape in the automated tape laying machine, the multi-layer substrate comprising:
a. a plastic layer comprising at least one plastic film having an outer film surface and an inner film surface; and
b. a fibrous layer having an outer fiber surface and an inner fiber surface wherein the inner fiber surface is adhered to the inner film surface; and

an uncured composite material layer comprising a fibrous reinforcement and an uncured resin matrix, the uncured composite material layer having a first composite surface that is located towards the mold when the uncured composite material is applied to the mold and a second composite surface that is releasably adhered to either the plastic layer or the outer fiber surface.

In addition, even where backing does not break, it needs to be discarded once peeled away from the tape. Accordingly, not only is it important to provide a tape backing that has sufficient dimensional stability, tear strength and burst strength to withstand the many forces that are applied to the backing as it travels through the automated tape layer, it would be desirable to provide a prepreg tape that is self-supporting (so as not to require backing) and substantially without tack so as to minimize, if not eliminate, resin buildup.

### SUMMARY

Provided herein in a first aspect is an automated process for laying up prepreg to form a three dimensional curable part. The steps of the process in this aspect include:

providing at room temperature prepreg, where the prepreg comprises a thermosetting resin component and fibers, wherein the thermosetting resin component is in solid form and softens with exposure to an elevated temperature condition; and

disposing with the application of an elevated pressure condition the prepreg about a surface of a tool in a three dimensional arrangement to form a three dimensional curable part set about the tool surface.

Provided herein in a second aspect is a process for making a three dimensional composite part. The steps of this process include:

placing the three dimensional curable part formed by the so-described process in the first aspect into an enclosure; and

placing the three dimensional curable part-containing enclosure under elevated pressure conditions sufficient to cure the three dimensional curable part to form a three dimensional composite part.

Provided herein in a third aspect is an automated process for placing pre-slit prepreg to form a layer of prepreg capable of forming a contoured composite part. The steps of this process include:

providing one more or more spools of pre-slit prepreg, where the pre-slit prepreg comprises a resin component and fibers, where the resin component is in solid form and softens with exposure to an elevated temperature condition;

dispensing from the one or more spools the pre-slit prepreg for placement onto a surface of a tool in a contoured arrangement to form a contoured curable part set about the tool surface, where the placement occurs with the application of an elevated pressure condition on the placed prepreg; and

adjusting the placed contoured curable part to form a predetermined part configuration about the tool surface.

Provided herein in a fourth aspect is a process for making a contoured composite part. The steps of this process include:

placing the contoured curable part formed by the so-described process in the third aspect into an enclosure; and

placing the contoured curable part-containing enclosure under elevated temperature and/or pressure conditions sufficient to cure the contoured curable part to form a contoured composite part.

Provided herein in a fifth aspect is an automated process for placing pre-slit prepreg to form a layer of prepreg capable of forming a contoured composite part. The steps of this process include:

providing at room temperature one more or more spools of pre-slit self-supporting, self-releasable, uncured prepreg, where the pre-slit prepreg comprises an unadvanced thermosetting resin component and a plurality of continuous fibers, wherein the pre-slit prepreg has an upper surface and a lower surface, and where at least one of the surfaces is substantially without tack;

dispensing from the one or more spools the pre-slit prepreg for placement onto a surface of a tool in a contoured arrangement to form a contoured curable part set about the tool surface, where the placement occurs with the application of an elevated pressure condition on the placed prepreg; and

adjusting the placed contoured curable part to form a predetermined part configuration about the tool surface.

Provided herein in a sixth aspect is a process for making a three dimensional composite part. The steps of this process include:

placing the three dimensional curable part formed by the so-described process in the fifth aspect into an enclosure; and

placing the three dimensional curable part-containing enclosure under elevated temperature and/or pressure conditions sufficient to cure the three dimensional curable part to form a three dimensional composite part.

Provided herein in a seventh aspect is an automated process for laying up uncured prepreg to form a curable three dimensional part. The steps of this process include:

providing at room temperature self-supporting, self-releasable, uncured prepreg, where the prepreg comprises an unadvanced thermosetting resin component and a plurality of continuous fibers, where the prepreg has an upper surface and a lower surface, and where at least one of the surfaces is substantially without tack; and

disposing about a tool with the application of an elevated temperature condition and an elevated pressure condition at a defined location on the prepreg in a three dimensional arrangement to form a curable three dimensional part.

Provided herein in an eighth aspect is a process for making a three dimensional composite part. The steps of this process include:

placing the three dimensional curable part formed by the so-described process in the seventh aspect into an enclosure; and

placing the three dimensional curable part-containing enclosure under elevated temperature and/or pressure conditions sufficient to cure the three dimensional curable part to form a three dimensional composite part.

### BRIEF DESCRIPTION OF THE DRAWINGS

FIG. 1 is a generic diagram of typical automated tape laying machine delivery head representative of the state of the art.

### DETAILED DESCRIPTION

Automated tape laying machines typically are gantry style and may have, for example, ten axes of movement with 5-axis movement on the gantry and 5-axis movement on the delivery head. A typical automated tape layer consists of a gantry structure (parallel rails), a crossfeed bar that moves on precision ground ways, a ram bar that raises and lowers the material delivery head, and a material delivery head which is attached to the lower end of the ram bar.

Commercial tape layers are generally configured specifically for lay up of flat or mildly contoured laminate applications using either flat tape laying machines (FILM) or contour tape laying machines (CTLM). On a gantry style tape layer, tobling (or a flat table) is commonly rolled under the gantry structure, secured to the floor and the machine delivery head is then initialized to the lay up surface.

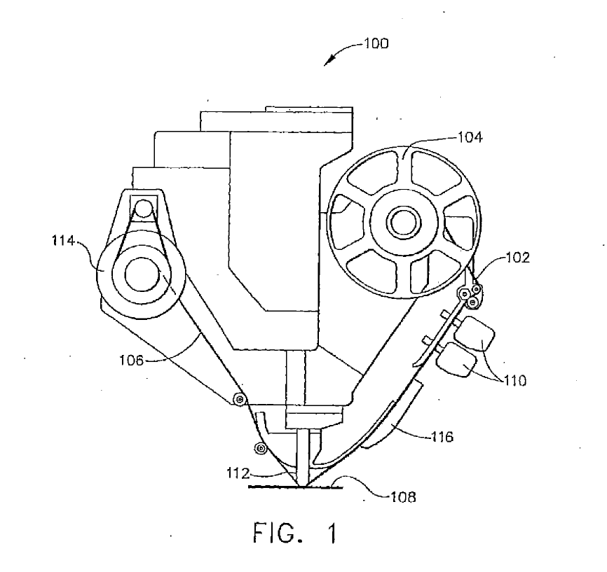

FIG. 1 provides an illustration of a typical tape laying machine delivery head 100. Delivery heads for FTLM and CTLM machines are basically the same configuration as that of delivery head 100 shown in FIG. 1. The delivery heads on commercial automated tape layers are typically configured to accept material widths of 3 inches, 6 inches and 12 inches. Flat tape layers typically use material in 6 inch and 12 inch widths. Contour tape layers typically use material in 3 inch and 6 inch widths. CTLM systems normally use the 3 inch or 6 inch wide material when laying up off flat plane contour surfaces.

Material 102 for tape layers generally comes in large diameter spools. The tape material 102 has a backing paper 106, which is extracted as the prepreg (resin impregnated fiber) is applied to the tool surface 108. The spool of material typically is loaded into the delivery head supply reel 104 and threaded through the upper tape guide chute and past the cutters 110. The material 102 then passes through the lower tape guides, under the segmented compaction shoe 112, and onto a backing paper take up reel 114. The backing paper is extracted and wound on a paper take up roller of paper take up reel 114. The delivery head 100 makes contact with the tool surface 108 and the tape material 102 is “placed” onto the tool surface 108 with compaction pressure. The tape laying machine typically lays tape on the tool surface 108 in a computer programmed path (course), cuts the material 102 at a precise location and angle, lays out tail, lifts delivery head 100 off the tool surface 108, retracts to the course start position, and begins laying the next course.

The delivery head 100 may have an optical tape flaw detection system that signals the machine control to stop laying tape material 102 when a flaw has been detected. The delivery head 100 also typically has a heating system 116 that heats the prepreg materials to increase tack levels for tape-to-tape adhesion. Heated tape temperatures generally range from 75° F. to 110° F.

Fiber placement is a similar process in which individual prepreg fibers, called tows, are pulled off spools and feed through a fiber delivery system into a fiber placement head, which is similar to delivery head 100 shown in FIG. 1. In the fiber placement head, tows may be collimated into a single fiber band and laminated onto a work surface, which can be mounted between a headstock and a tailstock. When starting a fiber band or course, the individual tows are fed through the head and compacted onto a surface, such as surface 108. As the course is being layed down, the head 100 can cut or restart the individual tows, thereby permitting the width of the fiber band to be increased or decreased in increments equal to one tow width. Adjusting the width of the fiber band minimizes if not eliminates excessive gaps or overlaps between adjacent courses. At the end of the course, the remaining tows may be cut to match the shape of the ply boundary. The head may then be positioned to the beginning of the next course.

During the placement of a course, each tow is dispensed at its own speed, allowing each tow to independently conform to the surface 108 of the part. The fibers are thus not restricted to geodesic paths, and as such can be steered to meet specific design goals. A rolling compaction device, combined with heat for tack enhancement, laminates the tows onto the lay-up surface 108. By pressing tows onto a work surface (or a previously laid ply), the tows are adhered to the lay-up surface 108 thereby removing trapped air and minimizing the need for vacuum debulking. It also allows the fiber to be laid onto concave surfaces.

A fiber placement head, like a tape laying head, may be provided with several axes of motion, using an arm mechanism, for example, and may be computer numeric controlled. The axes of motion may be necessary to make sure the head 100 is normal to the surface 108 as the machine is laminating tows. The machine may also have a number of electronic fiber tensioners, which may be mounted, for example, in an air conditioned creel. These tensioners may provide individual tow payout and maintain a precise tension. The head 100 may precisely dispense, cut, clamp and restrict individual prepreg tows.

### First Aspect

Now with respect to the first aspect, an automated process for laying up prepreg to form a three dimensional curable part is provided. The process may use the machine as so described. The steps of the process in this aspect include:

providing at room temperature prepreg, where the prepreg comprises a thermosetting resin component and fibers, wherein the thermosetting resin component is in solid form and softens with exposure to an elevated temperature condition; and

disposing with the application of an elevated pressure condition the prepreg about a surface of a tool in a three dimensional arrangement to form a three dimensional curable part set about the tool surface.

In this aspect, the prepreg may have a width in the range of 3 to 12 inches.

In this aspect, the elevated temperature condition at which the thermosetting resin component in solid form softens may be up to 250° F., such as in the range of 75 to 250° F. In this aspect, the elevated pressure condition may be up to 200 psi, such as up to 40 psi, desirably in the range of 0.5 to 40 psi.

### Second Aspect

With respect to the second aspect, a process for making a three dimensional composite part is provided. The steps of this process include:

placing the three dimensional curable part formed by the so-described process in the first aspect into an enclosure; and

placing the three dimensional curable part-containing enclosure under elevated pressure conditions sufficient to cure the three dimensional curable part to form a three dimensional composite part.

In this aspect, the enclosure may be under a vacuum, such as a vacuum of 20-30 inches of Hg.

In this aspect, the enclosure may be ventable. In this aspect, the three dimensional curable part-containing enclosure may be placed under elevated temperature conditions.

### Third Aspect

With respect to the third aspect, an automated process for placing pre-slit prepreg to form a layer of prepreg capable of forming a contoured composite part is provided. The steps of this process include:

providing one more or more spools of pre-slit prepreg, where the pre-slit prepreg comprises a resin component and fibers, where the resin component is in solid form and softens with exposure to an elevated temperature condition;

dispensing from the one or more spools the pre-slit prepreg for placement onto a surface of a tool in a contoured arrangement to form a contoured curable part set about the tool surface, where the placement occurs with the application of an elevated pressure condition on the placed prepreg; and

adjusting the placed contoured curable part to form a predetermined part configuration about the tool surface.

In this aspect, the pre-slit prepreg may have a width of 0.125 to 0.5 inches. In this aspect, the elevated temperature condition may be up to 250° F., such as in the range of 75 to 250° F. This elevated temperature condition may also be applied during dispensing.

In this aspect, the elevated pressure condition may be up to 200 psi, such as up to 40 psi, desirably in the range of 0.5 to 40 psi.

In this aspect, the elevated pressure condition may be maintained for a period of time of less than 10 seconds.

### Fourth Aspect

With respect to the fourth aspect, a process for making a contoured composite part is provided. The steps of this process include:

placing the contoured curable part formed by the so-described process in the third aspect into an enclosure; and

placing the contoured curable part-containing enclosure under elevated temperature and/or pressure conditions sufficient to cure the contoured curable part to form a contoured composite part.

In this aspect, the enclosure may be placed under a vacuum, such as one of 20-30 inches of Hg.

In this aspect, the enclosure may be ventable.

In this aspect, the contoured curable part-containing enclosure may be placed under elevated temperature conditions.

### Fifth Aspect

With respect to the fifth aspect, an automated process for placing pre-slit prepreg to form a layer of prepreg capable of forming a contoured composite part is provided. The steps of this process include:

providing at room temperature one more or more spools of pre-slit self-supporting, self-releasable, uncured prepreg, where the pre-slit prepreg comprises an unadvanced thermosetting resin component and a plurality of continuous fibers, wherein the pre-slit prepreg has an upper surface and a lower surface, and where at least one of the surfaces is substantially without tack;

dispensing from the one or more spools the pre-slit prepreg for placement onto a surface of a tool in a contoured arrangement to form a contoured curable part set about the tool surface, where the placement occurs with the application of an elevated pressure condition on the placed prepreg; and

adjusting the placed contoured curable part to form a predetermined part configuration about the tool surface.

In this aspect, the pre-slit prepreg may be 0.125 to 0.5 inches wide.

In this aspect, the elevated temperature condition may be up to 250° F., such as in the range of 75 to 250° F. The elevated temperature condition may be applied during dispensing.

In this aspect, the elevated pressure condition may be up to 200 psi, such as up to 40 psi, desirably in the range of 0.5 to 40 psi.

In this aspect, the elevated pressure condition may be maintained for a period of time of less than 10 seconds.

In this aspect, tack is measured as adhesion to a tool or prepreg surface

In this aspect, the resin component may be in solid form and softens with exposure to the elevated temperature condition.

### Sixth Aspect

With respect to the sixth aspect, a process for making a three dimensional composite part is provided. The steps of this process include:

placing the three dimensional curable part formed by the so-described process in the fifth aspect into an enclosure; and

placing the three dimensional curable part-containing enclosure under elevated temperature and/or pressure conditions sufficient to cure the three dimensional curable part to form a three dimensional composite part.

### Seventh Aspect

With respect to the seventh aspect, an automated process for laying up uncured prepreg to form a curable three dimensional part is provided. The steps of this process include:

providing at room temperature self-supporting, self-releasable, uncured prepreg, where the prepreg comprises an unadvanced thermosetting resin component and a plurality of continuous fibers, where the prepreg has an upper surface and a lower surface, and where at least one of the surfaces is substantially without tack; and

disposing about a tool with the application of an elevated temperature condition and an elevated pressure condition at a defined location on the prepreg in a three dimensional arrangement to form a curable three dimensional part.

### Eighth Aspect

With respect to the eighth aspect, a process for making a three dimensional composite part is provided. The steps of this process include:

placing the three dimensional curable part formed by the so-described process in the seventh aspect into an enclosure; and

placing the three dimensional curable part-containing enclosure under elevated temperature and/or pressure conditions sufficient to cure the three dimensional curable part to form a three dimensional composite part.

### Thermosetting Resin Component

The thermosetting resin composition includes as at least a portion thereof an oxazine component. The oxazine component may be embraced by the following structure:

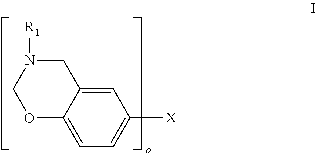

where o is 1-4, X is selected from a direct bond (when o is 2), alkyl (when o is 1), alkylene (when o is 2-4), carbonyl (when o is 2), thiol (when o is 1), thioether (when o is 2), sulfoxide (when o is 2), and sulfone (when o is 2), and R₁ is selected from hydrogen, alkyl and aryl.

Alternatively, the oxazine component may be embraced by the following structure:

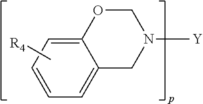

where p is 2, Y is selected from biphenyl (when p is 2), diphenyl methane (when p is 2), diphenyl isopropane (when p is 2), diphenyl sulfide (when p is 2), diphenyl sulfoxide (when p is 2), diphenyl sulfone (when p is 2), and diphenyl ketone (when p is 2), and R₄ is selected from hydrogen, halogen, alkyl and alkenyl.

More specifically, the oxazine may be embraced by one or more of the following structures:

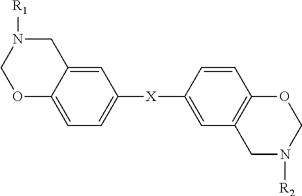

where X is selected from of a direct bond, CH₂, C(CH₃)₂, C=0, S, S═O and O═S═O, and R₁ and R₂ are the same or different and are selected from hydrogen, alkyl, such as methyl, ethyl, propyls and butyls, and aryl.

The oxazine thus may be selected from any of the following exemplified structures:

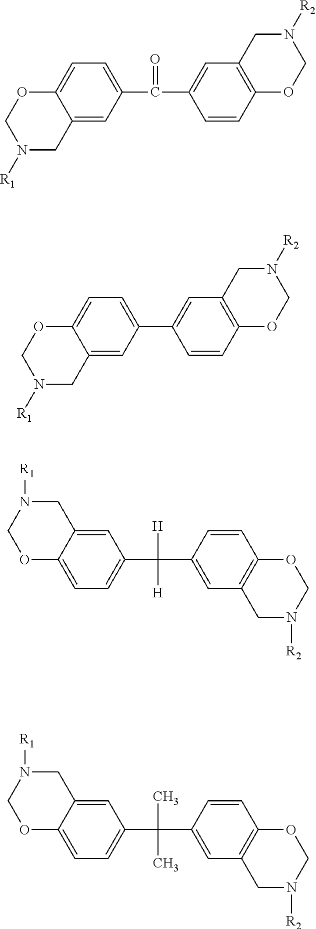

where R₁ and R₂ are as defined above.

Though not embraced by either of oxazine structures I or II additional oxazines may be embraced by the following structures:

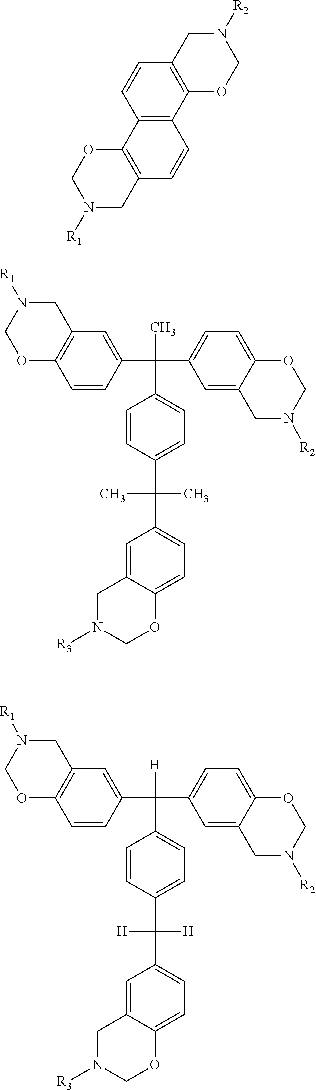

where R₁ are R₂ are as defined above, and R₃ is defined as R₁ or R₂.

Specific examples of these oxazines therefore include:

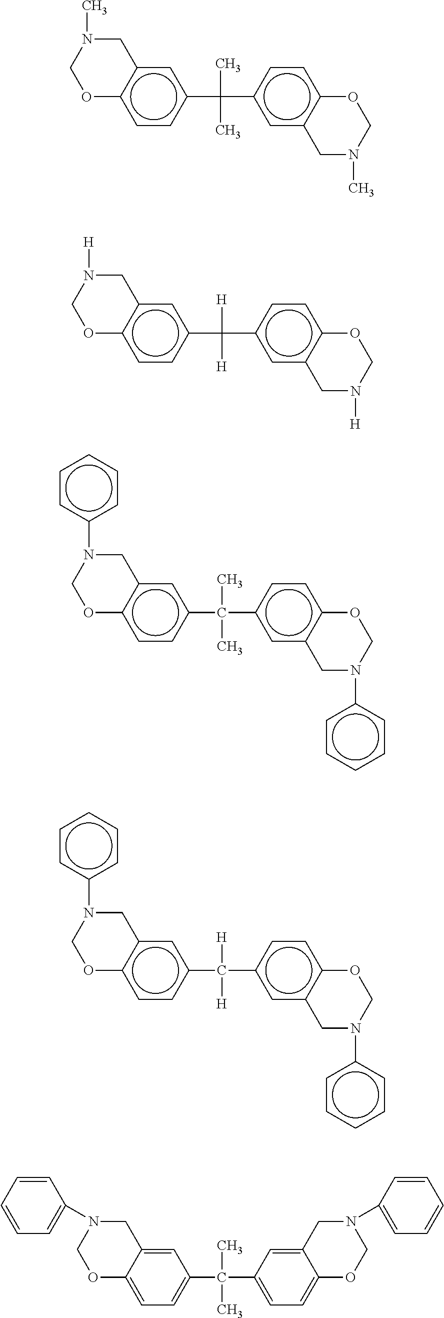

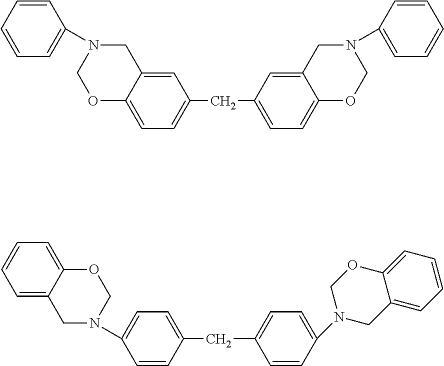 [SMILES: c1ccc(N2COc3ccc(Cc4ccc5c(c4)CN(c4ccccc4)CO5)cc3C2)cc1 ; c1ccc2c(c1)CN(c1ccc(Cc3ccc(N4COc5ccccc5C4)cc3)cc1)CO2]

The oxazine component may include the combination of multifunctional oxazines and monofunctional oxazines. Examples of monofunctional oxazines may be embraced by the following structure:

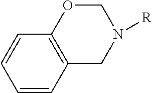

where R is alkyl, such as methyl, ethyl, propyls and butyls.

The oxazine component should be present in an amount in the range of about 10 to about 99 percent by weight, such as about 25 to about 75 percent by weight, desirably about 35 to about 65 percent by weight, based on the total weight of the composition.

### Fibers

The fibers may be constructed from unidirectional fibers, woven fibers, chopped fibers, non-woven fibers or long, discontinuous fibers.

The fiber chosen may be selected from carbon, glass, aramid, boron, polyalkylene, quartz, polybenzimidazole, polyetheretherketone, polyphenylene sulfide, poly p-phenylene benzobisoaxazole, silicon carbide, phenolformaldehyde, phthalate and napthenoate.

The carbon is selected from polyacrylonitrile, pitch and acrylic, and the glass is selected from S glass, S2 glass, E glass, R glass, A glass, AR glass, C glass, D glass, ECR glass, glass filament, staple glass, T glass and zirconium oxide glass.

1. An automated process for laying up prepreg to form a three dimensional curable part, comprising the steps of:
providing at room temperature prepreg, wherein the prepreg comprises a thermosetting resin component and fibers, wherein the thermosetting resin component is in solid form and softens with exposure to an elevated temperature condition; and
disposing with the application of an elevated pressure condition the prepreg about a surface of a tool in a three dimensional arrangement to form a three dimensional curable part set about the tool surface.

2. The process of claim 1, wherein the prepreg has a width in the range of 3 to 12 inches.

3. (canceled)

4. The process of claim 1, wherein the elevated temperature condition is in the range of 75 to 250° F.

5. The process of claim 1, wherein the elevated pressure condition is up to 200 psi.

6. (canceled)

7. The process of claim 1, wherein the elevated pressure condition is in the range of 0.5 to 40 psi.

8. A process for making a three dimensional composite part, comprising the steps of:
placing the three dimensional curable part formed by the process of claim 1 into an enclosure; and
placing the three dimensional curable part-containing enclosure under elevated pressure conditions sufficient to cure the three dimensional curable part to form a three dimensional composite part.

9. The process of claim 8, wherein the enclosure is under a vacuum.

10. The process of claim 8, wherein the enclosure is under a vacuum of 20-30 inches of Hg.

11. The process of claim 8, wherein the enclosure is ventable.

12. The process of claim 8, wherein the three dimensional curable part-containing enclosure is placed under elevated temperature conditions.

13. An automated process for placing pre-slit prepreg to form a layer of prepreg capable of forming a contoured composite part, comprising the steps of:
providing one more or more spools of pre-slit prepreg, wherein the pre-slit prepreg comprises a resin component and fibers, wherein the resin component is in solid form and softens with exposure to an elevated temperature condition;
dispensing from the one or more spools the pre-slit prepreg for placement onto a surface of a tool in a contoured arrangement to form a contoured curable part set about the tool surface, wherein the placement occurs with the application of an elevated pressure condition on the placed prepreg; and
adjusting the placed contoured curable part to form a predetermined part configuration about the tool surface.

14. The process of claim 13, wherein the pre-slit prepreg is 0.125 to 0.5 inches in width.

15. (canceled)

16. The process of claim 13, wherein the elevated temperature condition is in the range of 75 to 250° F.

17. The process of claim 13, wherein the elevated pressure condition is up to 200 psi.

18. (canceled)

19. The process of claim 13, wherein the elevated pressure condition is in the range of 0.5 to 40 psi.

20. The process of claim 13, wherein the elevated pressure condition is maintained for a period of time of less than 10 seconds.

21. The process of claim 13, wherein an elevated temperature condition of up to 250° F. is applied during dispensing.

22. A process for making a contoured composite part, comprising the steps of:
placing the contoured curable part formed by the process of claim 13 into an enclosure; and
placing the contoured curable part-containing enclosure under elevated temperature and/or pressure conditions sufficient to cure the contoured curable part to form a contoured composite part.

23. The process of claim 22, wherein the enclosure is under a vacuum.

24. The process of claim 22, wherein the enclosure is under a vacuum of 20-30 inches of Hg.

25. The process of claim 22, wherein the enclosure is ventable.

26. The process of claim 22, wherein the contoured curable part-containing enclosure is placed under elevated temperature conditions.

27. An automated process for placing pre-slit prepreg to form a layer of prepreg capable of forming a contoured composite part, comprising the steps of:
providing at room temperature one more or more spools of pre-slit self-supporting, self-releasable, uncured prepreg, wherein the pre-slit prepreg comprises an unadvanced thermosetting resin component and a plurality of continuous fibers, wherein the pre-slit prepreg has an upper surface and a lower surface, and wherein at least one of the surfaces is substantially without tack;
dispensing from the one or more spools the pre-slit prepreg for placement onto a surface of a tool in a contoured arrangement to form a contoured curable part set about the tool surface, wherein the placement occurs with the application of an elevated pressure condition on the placed prepreg; and
adjusting the placed contoured curable part to form a predetermined part configuration about the tool surface.

28. The process of claim 27, wherein the pre-slit prepreg is 0.125 to 0.5 inches in width.

29. (canceled)

30. The process of claim 27, wherein the elevated temperature condition is in the range of 75 to 250° F.

31. The process of claim 27, wherein the elevated pressure condition is up to 200 psi.

32. (canceled)

33. The process of claim 27, wherein the elevated pressure condition is in the range of 0.5 to 40 psi.

34. The process of claim 27, wherein the elevated pressure condition is maintained for a period of time of less than 10 seconds.

35. The process of claim 27, wherein an elevated temperature condition of up to 250° F. is applied during dispending.

36. The process of claim 27, wherein tack is measured as adhesion to a tool or prepreg surface.

37. The process of claim 27, wherein the resin component is in solid form and softens with exposure to an elevated temperature condition.

38. A process for making a three dimensional composite part, comprising the steps of:
placing the three dimensional curable part formed by the process of claim 27 into an enclosure; and
placing the three dimensional curable part-containing enclosure under elevated temperature and/or pressure conditions sufficient to cure the three dimensional curable part to form a three dimensional composite part.

39. The process of claim 38, wherein the enclosure is under a vacuum.

40. The process of claim 38, wherein the enclosure is under a vacuum of 20-30 inches of Hg.

41. The process of claim 38, wherein the enclosure is ventable.

42. The process of claim 38, wherein the three dimensional curable part-containing enclosure is placed under elevated temperature conditions.

43. An automated process for laying up uncured prepreg to form a curable three dimensional part, comprising the steps of:
providing at room temperature self-supporting, self-releasable, uncured prepreg, wherein the prepreg comprises an unadvanced thermosetting resin component and a plurality of continuous fibers, wherein the prepreg has an upper surface and a lower surface, and wherein at least one of the surfaces is substantially without tack; and
disposing about a tool with the application of an elevated temperature condition and an elevated pressure condition at a defined location on the prepreg in a three dimensional arrangement to form a curable three dimensional part.

44. A process for making a three dimensional composite part, comprising the steps of:
placing the three dimensional curable part formed by the process of claim 43 into an enclosure; and
placing the three dimensional curable part-containing enclosure under elevated temperature and/or pressure conditions sufficient to cure the three dimensional curable part to form a three dimensional composite part.
